(19) United States
(12) Patent Application Publication
(10) Pub. No.: US 2025/0212105 A1
(43) Pub. Date: Jun. 26, 2025

(54) METHODS, DEVICES, AND SYSTEMS FOR UE INITIATED NETWORK, SLICE MANAGEMENT AT SERVICE ENABLEMENT LAYER

(71) Applicant: CONVIDA WIRELESS, LLC, Wilmington, DE (US)

(72) Inventors: Dale SEED, Allentown, PA (US); Quang LY, North Wales, PA (US); Catalina MLADIN, Hatboro, PA (US); Lu LIU, Conshohocken, PA (US)

(21) Appl. No.: 18/851,869

(22) PCT Filed: Mar. 23, 2023
(86) PCT No.: PCT/US2023/016054

§ 371 Date: Sep. 27, 2024

Related U.S. Application Data
(60) Provisional application No. 63/324,327, filed on Mar. 28, 2022.

(51) Int. Cl. H04W 48/18; H04L 41/0806; H04L 41/0895

(52) U.S. Cl. CPC H04W 48/18; H04L 41/0806; H04L 41/0895

(57) ABSTRACT

Methods, devices, and systems for UE-initiated network slice management at a service enablement layer are described herein. In one aspect, a method can include receiving, by a NSCE client of a user equipment (UE) and from a VAL client of the UE, context information corresponding to application or user information of the UE; determining, by the NSCE client and based on the received context information, one or more network slices required by the VAL client; generating, by the NSCE client, one or more network slice management requests corresponding to the determined one or more network slices; and transmitting, by the NSCE client and to one or more NSCE servers, the generated one or more network slice management requests.

### CROSS-REFERENCE TO RELATED APPLICATIONS

This application claims the benefit of, and incorporates herein by reference, U.S. Provisional Application No. 63/324,327, titled “Methods, Devices, and Systems for UE Initiated Network Slice Management at Service Enablement Layer,” filed Mar. 28, 2022.

### BACKGROUND

FIG. 1 shows the Service Enabler Architecture Layer for Verticals (SEAL) in the 3GPP SA6 working group. SEAL is the service enabler architecture layer common to all vertical applications deployed over 3GPP systems. Hence SEAL provides a horizontal layer in which common services are made available to the vertical application layer. Some of the common services are: Location management; Group management; Configuration Management; Identity management; Key management; and Network resource management.

Vertical Application Layer (VAL) client(s) accesses the services offered by SEAL client(s) on the UE, which then transports traffic to SEAL server(s) using the SEAL-UU interface. The SEAL server routes the traffic to the destination VAL server(s) and may communicate with other SEAL server(s), which is not shown in FIG. 1. In addition, the SEAL server(s) has access to network exposure information via network interfaces with the 3GPP network. The SEAL services are accessed by VAL clients and VAL servers via API exposure of the common functions offered by the SEAL layer to all vertical applications. For example, SEAL supports network slice capability management.

A SEAL server may be deployed as part of a PLMN operator domain or a VAL service provider domain. When deployed in a VAL service provider domain, the SEAL server may have connections to multiple PLMN operator domains. The SEAL server connects to the 3GPP network system, and one SEAL server may support multiple VAL servers. The functional model of the SEAL layer may be described as on-network in which communications involve the 3GPP network or off-network in which communications occur between two UEs.

### SUMMARY

The disclosure provided herein describes methods wherein a service hosted on the UE initiates network slice management operations such that network slice(s) are allocated, modified, and deallocated based on the dynamically changing requirements and context of the UE such as context from applications and their users. The disclosed methods enable the allocation, modification, and deallocation of network slices for the UE with increased intelligence, efficiency, privacy, and performance by introducing network slice management functionality onto the UE itself. This functionality enables local network slice management decision making rather than relying completely on remote network slice management decision making in the network. This proposed functionality can also enable network slices to be defined in a more application specific manner, with increased granularity, and without introducing undue overhead into the system. Managing network slices using techniques that have a greater involvement of the UE can allow the network slices to be custom fitted and adapted to the needs of UEs and their applications and users with greater precision, dynamicity, and less wasted resources. Without this functionality in place, over or under provisioning of network slice resources is more likely to occur, especially as the UE requirements dynamically change (e.g., different applications on the UE are started and stopped by the user). Enabling the UE to take a more active role in the management of network slices ensure adequate network slices are allocated to the UE. This also helps conserve and optimize overall network slice resources across the system. This functionality also allows sensitive user context information to remain local on the UE rather than requiring sensitive information to be shared with network slice management services in the network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

FIG. 1 depicts the Service Enabler Architecture Layer for Verticals (SEAL) in the 3GPP SA6 working group;

FIG. 2 depicts the Network Slice Capability Exposure (NSCE) architecture defined by Release 18 of the Network Slice Capability Application Layer Exposure (NSCALE) (3GPP TR 23.700-99, Study on Network Slice Capability Exposure for Application Layer Enablement (NSCALE); V1.0.0);

FIG. 3 depicts an example of a process for user equipment (UE)-initiated network slice management operations;

FIG. 4 depicts a graphical user interface (GUI) of a UE that can be utilized for managing network slice resources for the UE;

FIG. 5A depicts an example communications system in which the methods and apparatuses described and claimed herein may be an aspect of;

FIG. 5B depicts a block diagram of an example apparatus or device configured for wireless communications;

FIG. 5C depicts a system diagram of an example radio access network (RAN) and core network;

FIG. 5D depicts a system diagram of another example RAN and core network;

FIG. 5E depicts a system diagram of another example RAN and core network;

FIG. 5F depicts a block diagram of an example computing system; and

FIG. 5G depicts a block diagram of another example communications system.

### DETAILED DESCRIPTION OF ILLUSTRATIVE EMBODIMENTS

In Release 18, 3GPP recognized the need for network slice capability exposure enhancements to SEAL that have yet to be realized and that enable trusted third parties to access the network slicing APIs defined and exposed by the 5G CN. Aspects of the study (3GPP SP-211509, Study on Network Slice Capability Exposure for Application Layer Enablement (NSCALE)) include further exposure of network slice lifecycle management operations to trusted third party application layer enablement to support network slice management and control. Such enablement supports the network slice related operations such as the mapping or migration of one or more vertical applications to one or more network slices. Also in scope for the study are network slice monitoring and triggering of dynamic network slice lifecycle management operations due to changes in application requirements (e.g., QoS) or a network slice status change.

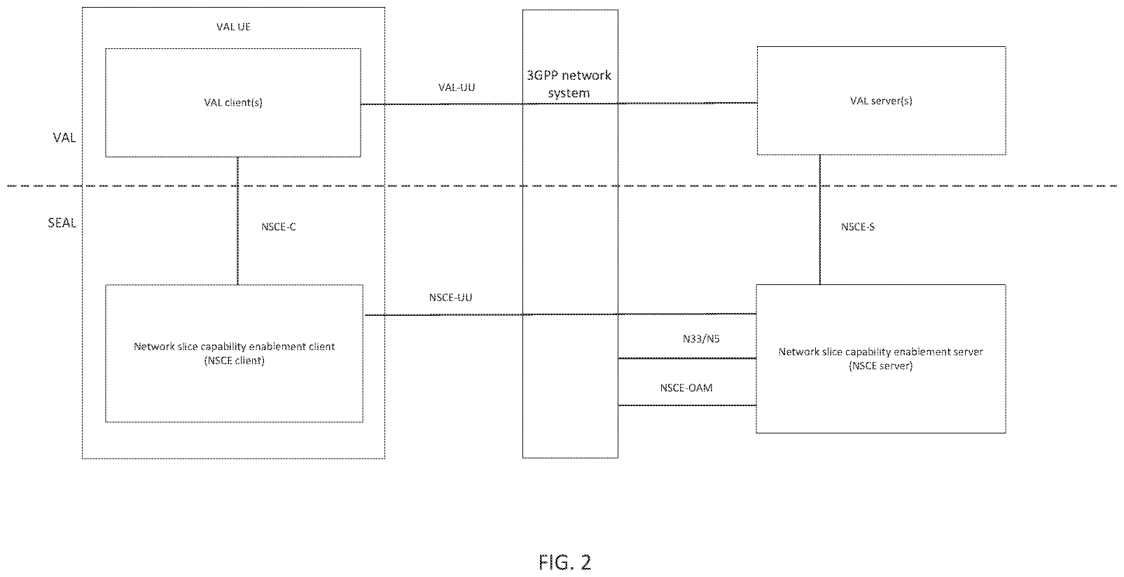

Thus far the Release 18 study has defined the NSCE architecture shown in FIG. 2 which is captured in TR 23.700-99 (3GPP TR 23.700-99, Study on Network Slice Capability Exposure for Application Layer Enablement (NSCALE); V1.0.0). The network slice capability exposure client communicates with the network slice capability exposure server over the NSCE-UU reference point. The network slice capability exposure client provides the support for network slice capability exposure functions to the VAL client(s) over the NSCE-C reference point. The VAL server(s) communicates with the network slice capability exposure server over the NSCE-S reference point. The network slice capability exposure server may communicate with the 5G Core Network functions via NEF (N33) reference point (for interactions with PCF, NSACF, etc.), or by interacting with PCF directly via N5, if permitted. The network slice capability exposure server may interact with the OAM system over the NSCE-OAM reference point (e.g., for network slice lifecycle management operations, fault supervision etc.).

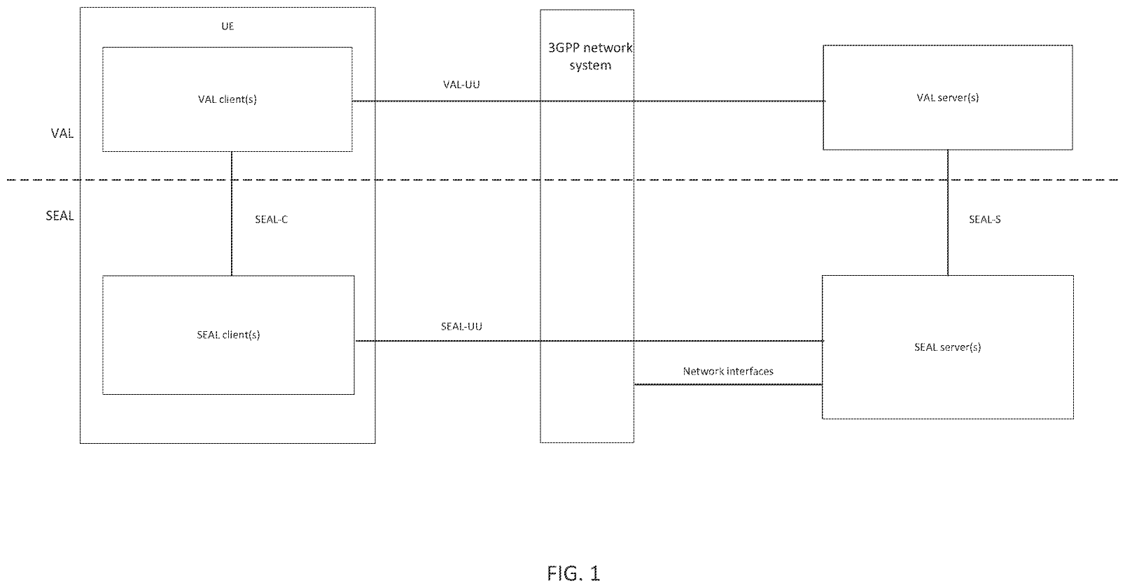

Note, although not shown in FIG. 2, NSCE client may be realized as functionality integrated within the SEAL client shown in FIG. 1. Likewise, the NSCE server may be realized as functionality integrated within the SEAL server.

Thus far, the Release 18 NSCALE study and architecture has primarily focused on defining procedures to enable a VAL server in the network to take a more active role in the management of network slices. These network slices are used to support communication between the VAL server (e.g., Application Server or Edge Application Server) and VAL clients (e.g., Application Clients) on one or more UEs. However, the study has yet to define procedures to enable a UE to take a more proactive and involved role in the management of network slices. This is a shortcoming of the current NSCALE study and architecture, since UEs are uniquely positioned in the system to assist with more optimal management of network slices. VAL clients on the UE are privy to application-centric context and information that other functions in the network may not be privy to. For example, constraints that require user data to be kept local on the UE to ensure user privacy, and/or performance constraints that limit the sharing of latency critical information with functions and services in the network.

Due to these types of constraints and requirements, the UE is well-positioned in the system to aid in the management of network slices. The UE can collect and analyze information local to the UE such as the current state or usage patterns of the applications on the UE and how users interact with the applications and services hosted on the UE. For example, locations or routes where the applications on the UE are expected to be operational as well as required network KPIs (e.g., bandwidth, latency, reliability, etc.) needed by the applications to meet Quality of Experience (QoE) expectations of user. Functionality on the UE itself, is optimally positioned in the system to collect, analyze, and process these types of information in a more secure and timely fashion rather than the UE sharing this information with other functions and services in the network to process and make less efficient remote decisions regarding network slice management.

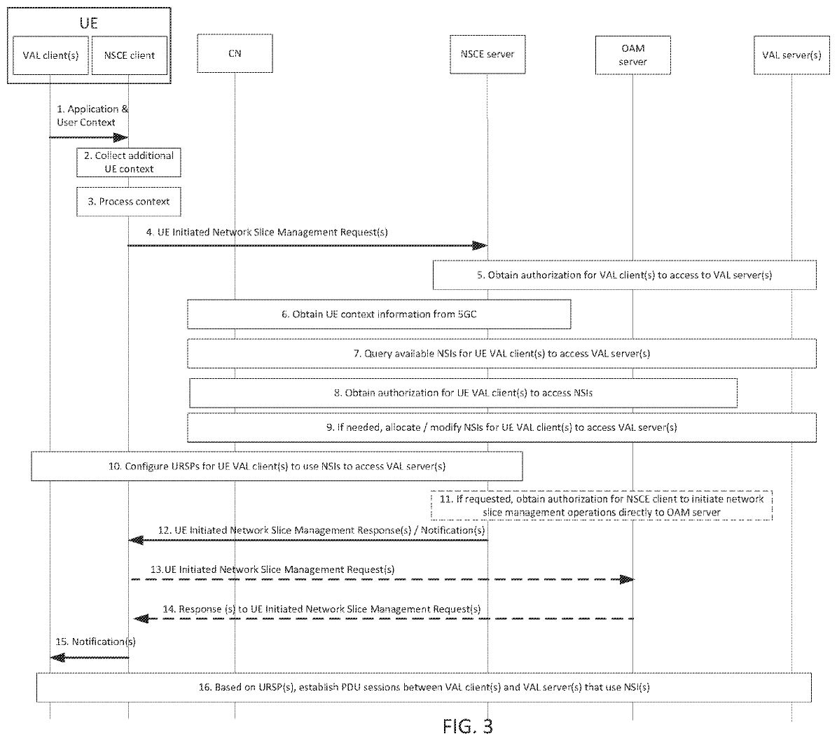

Proposed enhancements to the Release 18 NSCALE procedures for enabling UE initiated network slice management operations are shown in FIG. 3. The NSCE client and NSCE server may perform one or more of these steps in the sequence shown or the steps may be performed in different sequences then is shown.

In step 1, VAL clients on the UE can share application and/or user context information applicable to the management of network slices with the NSCE client on the UE. Types of application and/or user context information may include but are not limited to information defined in Table 1. The sharing of this information may be initiated by a VAL client based on the detection of various types of trigger events such as but not limited to those defined in Table 2. When a trigger event is detected, a VAL client may initiate the sharing and updating of this information such that the NSCE client can determine whether network slice management operations are required based on this information. For example, when a VAL client determines a change in the expected location or route of the UE has occurred, the NSCE client may be notified. The NSCE client may then perform any necessary network slice management operations. This may include coordinating with functions in the network to allocate new network slice(s) that may be used by the VAL client to communicate with the new VAL server. Likewise, the NSCE client may coordinate with functions in the network to deallocate network slice(s) no longer needed by the VAL client to communicate with the old VAL server.

TABLE 1
Application/User Context Applicable to Management of Network Slices

| Context | |
|---|---|
| Information | Definition |
| VAL server(s) | Identifiers for type(s) and/or instance(s) of VAL Server(s) that the VAL |
| | client(s) require interaction with. |
| VAL client(s) | Identifiers for VAL client(s) hosted on other UE(s) in the system and |
| | which the VAL client(s) on this UE interact with via the services |
| | provided by VAL server(s). |
| schedule(s) | Schedule(s) of when VAL client(s) on the UE are expected to be in |
| | operation and communicate with VAL server(s) and/or other VAL |
| | client(s) on other UE(s). The schedule(s) may consider schedule and |
| | usage patterns of user(s) that operate/interact with the VAL client(s). |
| location(s)/ | The current location or route of the UE or expected location(s) or |
| route(s) | route(s) of the UE where the VAL client(s) on the UE require |
| | communication with VAL server(s) and/or VAL client(s) on other |
| | UE(s). |
| mobility | Indication of whether the UE is a mobile or stationary device |
| indication | |
| criticality | Indication of whether the UE and/or individual VAL client(s) on the UE |
| indication | require non-critical or critical (e.g., emergency personnel and first |
| | responders), network connectivity and communication with VAL |
| | server(s) and/or VAL client(s) on other UE(s). |
| service continuity | Indication of whether the VAL client(s) on the UE require service |
| indication | continuity for scenarios where the UE is mobile and transitions between |
| | different PLMNs, DNS, EDNs, etc. |
| edge service | Indication of whether the VAL client(s) on the UE require edge-based |
| indication | VAL server(s), the types of edge-based VAL server(s), and/or the |
| | required proximity of the edge-based VAL server(s) to the UE. |
| communication | Whether the VAL client(s) on the UE require communication with the |
| direction | VAL server(s) and/or VAL client(s) on other UE(s) in the uplink or |
| | downlink directions or both. |
| communication | Required modes of communication required between the VAL client(s) |
| mode | on the UE and VAL server(s) or VAL client(s) on other UE(s). Some |
| | examples of communication modes may include but are not limited to |
| | unicast, multicast and/or broadcast or 3GPP, non-3GPP or ProSe. |
| required mobility | Required minimum speed that the UE can travel while required network |
| | availability and reliability are maintained allowing the VAL client(s) on |
| | the UE to maintain effective communication with VAL server(s) and/or |
| | VAL client(s) on other UE(s). |
| observed | Actual speed that UE can travel, as observed by VAL client(s) before |
| mobility | network availability and reliability degrade to a level that prevents the |
| | VAL client(s) on the UE to effectively communication with VAL |
| | server(s) and/or VAL client(s) on other UE(s). |
| required end-to- | Required maximum end-to-end response time in the uplink and/or |
| end response | downlink directions for request(s) initiated between VAL client(s) on |
| time | the UE and VAL server(s) and/or VAL client(s) on other UE(s). |
| observed end-to- | Actual end-to-end response time observed by VAL client(s) on the UE |
| end response | when initiating requests with VAL server(s) and/or VAL client(s) on |
| time | other UE(s). |
| required end-to- | Required maximum end-to-end variation in response time (i.e. jitter) in |
| end response | the uplink and/or downlink directions for a flow of requests and |
| time variation | responses exchanged between VAL client(s) on the UE and VAL |
| | server(s) and/or VAL client(s) on other UE(s). |
| observed end-to- | Actual end-to-end variation in response time observed by VAL client(s) |
| end response | when exchanging a flow of requests and responses with VAL server(s) |
| time variation | and/or VAL client(s) on other UE(s). |
| required end-to- | Required minimum data exchange rate in the uplink and/or downlink |
| end bandwidth | directions (i.e., bandwidth) required between VAL client(s) and VAL |
| | server(s) |
| observed end-to- | Actual data exchange rate (i.e., bandwidth) observed by VAL client(s) |
| end bandwidth | when communicating with VAL server(s) and/or VAL client(s) on other |
| | UE(s). |
| required end-to- | Required maximum loss rate of packets transmitted end-to-end in the |
| end reliability | uplink and/or downlink directions between VAL client(s) and VAL |
| | server(s) and/or VAL client(s) on other UE(s). |
| observed end-to- | Actual loss rate of packets observed by VAL client(s) when |
| end reliability | communicating with VAL server(s) and/or VAL client(s) on other |
| | UE(s). |
| required location | Required maximum amount of error in the measured location of the UE |
| accuracy | by the network. |
| observed location | Actual amount of error in the measured location of the UE observed by |
| accuracy | VAL client(s). |

TABLE 2
Events Triggering the Sharing of Application/User Context

| Trigger Event | Definition |
|---|---|
| transition to | If/when a VAL client stops communicating with VAL server(s) and/or |
| different VAL | starts communicating with new VAL server(s), the VAL client may |
| server(s) | notify the NSCE client such that any required network slice |
| | management operations may be performed. For example, allocate new |
| | network slice(s) used by the VAL client to communicate with new VAL |
| | server(s) and/or deallocate network slice(s) no longer needed by the |
| | VAL client to communicate with old VAL server(s). |
| transition to | If/when a VAL client stops communicating with other VAL client(s) |
| different VAL | and/or starts communicating with new VAL client(s), the VAL client |
| client(s) | may notify the NSCE client such that any required network slice |
| | management operations may be performed. For example, initiating the |
| | allocation of new network slice(s) used by the VAL client to |
| | communicate with new VAL client(s) and deallocation of network |
| | slice(s) no longer needed by the VAL client to communicate with old |
| | VAL client(s). |
| schedule change | If/when a change in the current or expected schedule(s) of |
| | communication between VAL client(s) and VAL server(s) and/or VAL |
| | client(s) on other UE(s) is detected, the VAL client(s) may notify the |
| | NSCE client such that any required network slice management |
| | operations may be performed. For example, the NSCE client may |
| | initiate the modification of the allowed times for which the VAL |
| | client(s) are permitted to use the existing network slice(s) to |
| | communicate with the VAL server(s). Alternatively, the NSCE client |
| | may instead initiate allocation of new network slice(s) that can be used |
| | during the new scheduled times by the VAL client(s). The NSCE client |
| | may also initiate deallocation of network slice(s) no longer needed by |
| | the UE and VAL client(s) due to the schedule changes. |
| location/route | If/when a change in the current or expected location or route of the UE |
| change | occurs, the VAL client(s) may notify the NSCE client such that any |
| | required network slice management operations may be performed. For |
| | example, the NSCE client may initiate the modification of the allowed |
| | locations, routes or DNNs for which the VAL client(s) are permitted to |
| | use the existing network slice(s) to communicate with the VAL |
| | server(s) and/or VAL client(s) on other UE(s). Alternatively, the NSCE |
| | client may instead initiate allocation of new network slice(s) that can be |
| | used at the current or expected locations or routes by the VAL client(s). |
| | The NSCE client may also initiate deallocation of network slice no |
| | longer needed by the UE and VAL client(s) due to the change in |
| | locations or routes. |
| mobility change | If/when the mobility status changes (e.g., stationary to mobile or vice |
| | versa) or the speed of the UE changes, the NSCE client may be notified |
| | such that any required network slice management operations may be |
| | performed. For example, the NSCE client may initiate the modification |
| | of the existing network slice(s) used for communication with VAL |
| | server(s) and/or VAL client(s) on other UE(s) based on changes to the |
| | UE speed or mobility status. Alternatively, the NSCE client may |
| | instead initiate allocation of new network slice(s) that can be used by |
| | the VAL client(s) for the UE's adjusted speed or mobility status. The |
| | NSCE client may also initiate deallocation of network slice(s) no longer |
| | needed by the UE and VAL client(s) due to the mobility changes. |
| criticality change | If/when criticality requirements of the UE and/or individual VAL |
| | client(s) on the UE change (e.g. from non-critical to critical), the NSCE |
| | client may be notified such that any required network slice management |
| | operations may be performed. For example, the NSCE client may |
| | initiate switching from network slices that do not support critical |
| | communication services over to network slices that do and vice versa. |
| | Alternatively, the NSCE client may initiate modification of a network |
| | slice to enable or disable critical communication services within the |
| | slice. |
| service continuity | If/when the service continuity requirements of VAL client(s) change, |
| change | the NSCE client may be notified such that any required network slice |
| | management operations may be performed. For example, the NSCE |
| | client may initiate allocation, modification and/or deallocation of |
| | network slices in different PLMNs, DNs and/or EDNs when is a UE is |
| | mobile and transitions between different networks or regions. |
| edge service | If/when edge service requirements of VAL client(s) change, the NSCE |
| change | client may be notified such that any required network slice management |
| | operations may be performed. For example, if the proximity |
| | requirement for edge services changes (e.g. VAL client requires use of |
| | edge services in closer proximity to the UE to reduce latency), for |
| | NSCE client may initiate allocation, modification and/or deallocation of |
| | network slices in different EDNs. |
| communication | If/when VAL client(s) communication direction requirements change |
| direction change | from uplink, downlink or bi-directional, the NSCE client may be |
| | notified such that any required network slice management operations |
| | may be performed. For example, NSCE client may initiate allocation, |
| | modification and/or deallocation of network slices which support the |
| | communication directionality needs of the VAL client(s). |
| communication | If/when required communication modes (e.g., unicast, multicast and/or |
| mode change | broadcast, 3GPP, non-3GPP, ProSe) change between VAL client(s) and |
| | VAL server(s) and/or VAL client(s) on other UE(s), the NSCE client |
| | may be notified such that any required network slice management |
| | operations may be performed. For example, NSCE client may initiate |
| | allocation, modification and/or deallocation of network slices which |
| | support the required communication modes needed by the VAL |
| | client(s). |
| end-to-end | If/when changes to required or observed end-to-end latency, jitter, |
| latency, jitter, | bandwidth and/or reliability are detected by the VAL client(s), the |
| bandwidth and/or | NSCE client may be notified such that any required network slice |
| reliability change | management operations may be performed. For example, NSCE client |
| | may initiate allocation or modification of network slices made available |
| | to the UE and VAL client(s) such that the updated end-to-end latency, |
| | jitter, bandwidth and/or reliability requirements are met. For example, |
| | network slice selection may be made based on Slice/Service Type (SST) |
| | (e.g., URLLC, eMBB, etc.) such that slices are selected based on |
| | required latency, jitter, bandwidth and/or reliability. |
| location accuracy | If/when changes in required or observed location accuracy are detected |
| change | by the VAL client(s), the NSCE client may be notified such that any |
| | required network slice management operations may be performed. For |
| | example, NSCE client may initiate allocation or modification of |
| | network slices made available to the UE and VAL client(s) such that |
| | network slices supporting location services with the required level of |
| | location accuracy are made available to the UE and VAL client(s). |

At Step 2, in addition to any context information that the NSCE client receives from VAL client(s), the NSCE client may also collect additional context information applicable to the management of network slices such as but not limited to the context shown in Table 3. The collecting of this information may be initiated by the NSCE client. Alternatively, other entities in the system may share this context information with the NSCE client. These other entities may include but are not limited to other service enablers or functions hosted on the UE itself or that may reside in the network. For example, functions in the operating system of the UE, functions in the protocol stack of the UE, functions in the modem chipset of the UE, and/or functions or services in the network (e.g., NSCE server, OAM service, etc.).

TABLE 3
Additional Network Slice Context Collected by NSCE Client

| Context | |
|---|---|
| Information | Definition |
| network slice | The configuration parameters and resources of each network slice |
| configuration | allocated for use by the UE, such as Configured NSSAI or Allowed |
| | NSSAI. In addition, the scheduled times which VAL client(s) on the UE |
| | are permitted to use a given network slice, the locations, or routes from |
| | which VAL client(s) on the UE are permitted to use a given network |
| | slice, the VAL server(s) that the VAL client(s) may communicate with |
| | using a given network slice. |
| network slice | The status of network slice(s) such as whether or not network slice(s) |
| status | allocated to the UE are currently available for use by the UE and/or if |
| | any of the slices have incurred a fault condition (e.g., have become |
| | overloaded). |
| network slice | Usage information of network slice(s) by the VAL client(s) on the UE |
| utilization | such as the scheduled times when the VAL client(s) communicate with |
| | VAL server(s), the locations, or routes from which the VAL client(s) |
| | communicate with VAL server(s), the directionality and/or mode of this |
| | communication, the observed mobility and speed of the UE, the end-to- |
| | end bandwidth consumed. |
| Application | A list of application servers accessible via the current network slice(s) |
| servers | the UE is allowed to access. The NSCE client can collect this |
| associated with | information via inspection of the URSP(s) configured on the UE. For |
| network slice | example, the NSCE client can extract application descriptor and |
| | network slice selection information (S-NSSAI) contained within the |
| | URSPs. |
| Network | A list of network functions (e.g., NWDAF, NEF) accessible via the |
| functions | current network slice(s) that the UE is allowed to access. If network |
| associated with | function descriptor information is added to URSP(s), the NSCE client |
| network slices | can extract which network functions are available to the UE via which |
| | of the available network slices. |
| Network service | A list of network service capabilities (e.g., ADAES, SEAL) accessible |
| capabilities | via the current network slice(s) the UE is allowed to access. If network |
| associated with | service descriptor information is added to URSP(s) or provided to the |
| network slices | NSCE client by other means (e.g., shared by NSCE server), the NSCE |
| | client can extract which network services are available to the UE via |
| | which of the available network slices. |
| Non-application | Lower-level context that is not specific to an individual application or |
| centric context | user. For example, context or events detected by operating system of the |
| | UE, functions in the protocol stack of the UE, functions in the modem |
| | chipset of the UE, and/or functions or services in the network. Some |
| | examples may include but are not limited to the following: |
| | RSSI measurements that may apply to one or more network slices |
| | allocated to a UE, |
| | PDU session related events (e.g., establishment, tear-down, |
| | modification) that may apply to one or more network slices allocated |
| | to a UE, |
| | URSP related events (e.g., URSP creation, modification, deletion) |
| | Changes in UE location or speed detected by the local UE (e.g., GPS |
| | capability of the UE) or by the network. |

At Step 3, the NSCE client may process the context it receives and/or collects to determine network slice(s) required by the one or more VAL clients on the UE and/or network slice management operations that may need to be performed regarding these network slices. This processing may include but is not limited to one or more types of processing defined in Table 4. Based on processing of context, the NSCE client may trigger one or more events such as but not limited to those defined in Table 5.

TABLE 4
Operations Performed on Context Applicable
to Management of Network Slices

| Types of | |
|---|---|
| processing | Definition |
| store | Storing and maintaining a history of the received and/or |
| context | collected network slice management context. |
| aggregate | Aggregating the received, collected and/or stored network |
| context | slice management context to identify commonalities across |
| | VAL clients and/or users of VAL clients to determine |
| | overall network slice requirements of the UE. |
| analyze | Analyzing received, collected and/or stored network slice |
| context | management context to detect unique network slice |
| | requirements for individual VAL clients, common |
| | requirements across multiple VAL clients, and/or usage of |
| | network slices by VAL client(s) of the UE. |
| determine | Determine the set of network slice(s) required by the VAL |
| network | client(s) on the UE based on analysis results (e.g., slice |
| slices and | type(s), slice usage schedule(s), slice usage location(s). |
| management | |
| operations | |

TABLE 5
Events Triggered by Processing of Context

| Events | |
|---|---|
| Triggering | |
| Processing | Definition |
| insufficient | The NSCE client may detect that VAL client(s) on the |
| network | UE require a certain type of network slice that is not |
| slice(s) | currently allocated to the UE. The NSCE client may also |
| | detect that a network slice allocated to the UE is the |
| | required type, however, it lacks sufficient resources and/or |
| | privileges that allow the VAL client(s) on the UE to use the |
| | network slice to perform their required communication with |
| | VAL server(s) or VAL client(s) on other UE(s). The NSCE |
| | client may detect that the resources are insufficient based |
| | on requirements other than communications, e.g. compute |
| | resources for offloaded processes to the slice. To perform |
| | this detection, the NSCE client can inspect the current set |
| | of URSP(s) configured on the UE and compare URSP |
| | information (e.g., application descriptor, network slice |
| | selection, location criteria, time window) against the |
| | requirements of the VAL clients. The NSCE client may |
| | also inspect context information from other sources as well |
| | (e.g., NSCE server). If sufficient network slices are not |
| | found for one or more VAL client(s), the NSCE client can |
| | generate this event. |
| unused | The NSCE client may detect that VAL client(s) on the UE |
| network | either no longer requires the use of one or more network |
| slice(s) | slices allocated to the UE or will not require the use some |
| | calculated time in the future. To perform this detection, the |
| | NSCE client can inspect the current set of URSP(s) |
| | configured on the UE and compare URSP information |
| | (e.g., application descriptor, network slice selection, |
| | location criteria, time window) against the requirements of |
| | the VAL client(s). The NSCE client may also inspect |
| | context information from other sources as well (e.g., NSCE |
| | server). If unused network slice(s) are detected, then NSCE |
| | client can generate this event. |
| under/over | The NSCE client may detect that network slice(s) allocated |
| utilized | to a UE may be currently over or under sized/provisioned |
| network | for the current needs and requirements of the VAL client(s) |
| slice(s) | of UE. The NSCE client may also predict that the network |
| | slice(s) currently allocated to a UE may become over or |
| | under sized/provisioned in the future based on the |
| | predicted requirements of the VAL client(s) of UE. For |
| | example, the NSCE client may monitor and/or detect that |
| | current and/or future communication patterns of the VAL |
| | client(s) are and/or will be under or over utilizing network |
| | slice resources. For example, the NSCE client may detect |
| | delays or dropped packets or negative feedback from VAL |
| | client(s) or users for the case where VAL client(s) attempt |
| | to over utilize a network slice having insufficient |
| | resources. The NSCE client may collect statistics such as |
| | VAL client activity and use these statistics to predict future |
| | behavior and slice requirements of the VAL clients. |

At Step 4, based on detecting a trigger event in Step 3, the NSCE client may initiate one or more network slice management requests towards one or more NSCE servers and/or OAM services in the network to perform network slice management operations. For example, the NSCE client may initiate request(s) to allocate one or more new network slices for use by the UE and its VAL client(s), modify one or more network slices already allocated to the UE and its VAL client(s), and/or deallocate one or more network slices no longer required by the UE and its VAL client(s). In addition, the NSCE client may subscribe to receive notification(s) from the NSCE server regarding one or more types of network slice management events of interest to the NSCE client, the UE and/or VAL client(s) on the UE. A request may include but is not limited to one or more of the information elements defined in Table 6.

TABLE 6
Network Slice Management Request Information Elements

| Information | |
|---|---|
| Element | Definition |
| identifiers | Identifier(s) of UE(s), VAL client(s), VAL server(s) |
| | and/or NSCE client having applicability to the |
| | requested network slice management operation(s) |
| VAL client context | application context received from one or more VAL |
| | clients such as the types of context defined in Table |
| | 1. |
| NSCE client | Context collected or derived by the NSCE client |
| context | such as the types of context defined in Table 3. |
| network slice | One or more network slice operations that the NSCE |
| management | client is requesting that the NSCE server perform on |
| operation(s) | behalf of the NSCE client such as but not limited to: |
| | allocating, modifying, or deallocating a network |
| | slice |
| network slice | Determined network slice requirements and/or |
| requirements or | settings (e.g., slice type(s), slice usage schedule(s), |
| settings | slice usage location(s)) for one or more network |
| | slices required by the UE |
| Direct network | An indication that the NSCE client is requesting the |
| slice management | NSCE server to obtain authorization for the NSCE |
| operation | client to perform one or more network slice |
| request indicator | operations directly with an OAM service in the |
| | network. If the NSCE client has an authorization |
| | token available which allows it to perform network |
| | slice operations directly with an OAM service in the |
| | network, it may include it within this element. |
| network slice | One or more notification criteria pertaining to |
| notification | network slice management events which the NSCE |
| criteria | client is interested in being notified about. Some |
| | examples include: |
| | Notifications of network slice instance |
| | errors/faults (e.g., overloaded, unavailable, etc.) |
| | Notifications of network slice handovers/ |
| | transitions required or that have occurred |
| | Notifications of new network slice instance |
| | allocations, modifications, or deallocations |
| | performed in network |
| | Notifications regarding network slice operations |
| | that the NSCE client is to initiate regarding one |
| | or more network slice instances and/or VAL |
| | client(s) |
| | Notifications of new network slice types |
| | supported in the network |
| | Notifications of network slice types no longer |
| | supported in the network |
| | Notifications of available network slice types |
| | and/or instances available to the UE in a DN, |
| | EDN, PLMN (e.g., when mobile UE |
| | moves/roams) |
| network slice | The network address (e.g., URI) where network |
| management | management slice notifications are to be sent to the |
| notification | NSCE client. |
| callback address | |

At Step 5, upon receiving a network slice management request from a NSCE client, the NSCE server may first authenticate the NSCE client. Once the NSCE client has been authenticated and before performing any network slice management request(s) on behalf of the NSCE client, the NSCE server may check whether the VAL client(s) specified in the request are authorized to access the VAL server(s) specified in the request. To perform this check, the NSCE server may interact with other entities in the system such as but not limited to an authorization service or a VAL server. If one or more of the specified VAL clients(s) are found not to have authorization to access VAL server(s), the NSCE server may try and obtain authorization for the VAL client(s) by sending authorization request(s) to other entities in the system such as but not limited to an authorization service or a VAL server. The authorization request(s) may include one or more information elements from the request(s) that the NSCE server receives from NSCE client(s) such as those defined in Table 6. If the NSCE server determines the VAL client(s) are authorized to access the specified VAL server(s), the NSCE server may continue processing the network slice management request, otherwise the NSCE server may return an error condition back to the NSCE client indicating the VAL client(s) lack sufficient privileges to access the specified VAL server(s) and hence the network slice management operation(s) were not performed.

At Step 6, the NSCE server may send one or more requests to functions in the core network (e.g., NEF, PCF, NWDAF, etc.) and receive one or more responses or notifications back from these core network functions. These requests may obtain additional context information regarding the UE initiating the network slice management request, other UE(s) specified in the network slice management request, and/or VAL server(s) specified in the network slice management request. The types of context information obtained from the core network functions may include but are not limited to context defined in Table 7.

TABLE 7
Context Information Obtained from Core Network Functions

| Information | |
|---|---|
| Element | Definition |
| UE location(s) | The current or predicted location of the UE hosting |
| | the NSCE client and/or the location(s) of other |
| | UE(s) targeted for communication with this UE and |
| | specified in the request from the NSCE client. |
| current network | Current network slice(s) allowed for use by the |
| slice(s) | UE(s), the VAL client(s) on the UE(s), and/or the |
| | VAL server(s) that the VAL client(s) are to |
| | communicate with. Information may include |
| | network slice identifiers (NSSAI, SST, etc.), DNNs |
| | associated with network slices, scheduled time |
| | windows network slices are available for use, |
| | locations that network slices are available for use, |
| | statistics, and predictions of the slice load, etc. |
| URSP(s) | URSP(s) currently configured on the UE hosting the |
| | NSCE client and/or other UE(s) that communicate |
| | with this UE. The URSP(s) may include information |
| | related to network slices such as S-NSSAI(s), |
| | DNN(s), time window and location criteria. |
| network slice | Notifications pertaining to network slice |
| notification | management events which the NSCE server is |
| events | interested in being notified about such as those |
| | specified by the NSCE client in Table 6. |

At Step 7, the NSCE server may send one or more network slice query requests to one or more network slice management functions in the system and receive one or more query responses in return. These functions may reside in the core network (e.g., NSACF) and/or elsewhere in the system (e.g., OAM service). The query request(s) may include one or more information elements from the request(s) that the NSCE server receives from the NSCE client(s) such as those defined in Table 6 or context information that the NSCE server obtains from core network functions as defined in Table 7. The query request(s) may be used by the NSCE server to determine the types of network slices (e.g., SST values) supported by the core network and the locations in the network where these types of network slices are supported (e.g., within specific regions, domains in the network and/or within specific edge data networks). The query request(s) may also be used by the NSCE server to determine whether there are any existing network slice instances (NSIs) already allocated which meet the minimum required service or QoE KPIs of the VAL client(s) on the specified UE(s) and that have availability to service the UE(s) during their required communication schedule(s) and/or for their expected location(s) and/or routes. The NSCE server may also receive information from VAL servers regarding network slice types and/or instances that the VAL servers support and/or are currently using.

At Step 8, after determining the types of network slices supported by the core network and/or the available instances of network slices already allocated within the network (which meet the requirements of the specified VAL clients and/or are being used by VAL servers), the NSCE server may check whether these UE(s) and their VAL client(s) are authorized to access and use these network slice types and instance(s). To perform this check, the NSCE server may use the list of allowed network slices provided in the request from the NSCE client. Alternatively, the NSCE server may initiate one or more requests to one or more functions in the system. For example, the NSCE server may initiate requests to a function in the core network (e.g., NEF, UDR, UDM) or an OAM service to check whether a UE's subscription permits access to certain network slice types or existing network slice instances already allocated in the network. If the UE(s) and/or the VAL client(s) are found not to have authorization to access the network slice types or instances, the NSCE server may initiate one or more requests to other network slice management functions in the system (e.g., OAM service) to try and obtain (on their behalf) authorization privileges. If ultimately, the UE(s) and/or their VAL client(s) cannot be granted access to their required network slice types or instances, the NSCE server may return an error condition back to the NSCE client indicating the VAL client(s) lack sufficient privileges to access network slice types or instances and hence the requested network slice management operation(s) cannot be performed.

At Step 9, if after querying the current network slice instances and the NSCE server determines there are no slice instance(s) currently available and/or accessible that meet the minimum requirements of the UE(s) and their VAL client(s) specified in the request, the NSCE server may initiate one or more requests to trigger the allocation and/or modification of one or more network slice instances for use by the UE(s), their VAL client(s) and/or the VAL server(s) of interest to the VAL client(s). To trigger the allocation and/or modification of one or more network slice instances, the NSCE server may issue one or more requests to other functions in the system such as core network functions (e.g., NEF, NSACF, etc.), OAM functions responsible for managing network slices and/or VAL servers. Within the request(s), the NSCE server may include information and context such as but not limited to the elements proposed in Table 1, Table 3, Table 6 and/or Table 7. When attempting to allocate or modify network slice instances, the NSCE server may first analyze or obtain information of the existing network slice instances that have already been allocated and in use within the network. Via this analysis, the NSCE server may identify the number, types and identities of the UE(s), VAL client(s) and VAL server(s) already assigned to and/or using these allocated network slice instances. The NSCE may also identify the locations, routes and schedules of the UE(s), VAL client(s) and/or VAL server(s) using these allocated network slice instances.

Based on this information, the NSCE server may determine whether there are sufficient resources available within one or more allocated network slices being requested in the received request. The NSCE server may also determine whether existing network slices are already being used by the UE(s), VAL client(s) and/or VAL server(s) and if so, prioritize the use of these existing network slice instance to try and reduce the number of different network slice instances required to be used by a given UE, VAL client or VAL server which can optimize device and network resources in the system. In addition to allocating and/or modifying network slice instances, the NSCE server may also issue one or more requests to deallocate network slice instances if needed. For example, if the NSCE server detects there are no longer any UEs requiring a particular network slice instance, it may issue a request to deallocate the network slice instance. The NSCE server may also subscribe to receive notification from the OAM function regarding network slice instance events of interest such as one or more of the notification events defined in the request from the NSCE client defined in Table 6.

At Step 10, if the NSCE server may determine network slice instance(s) that the UE is able to access and use, the NSCE may configure UE Route Selection Policy(s) (URSPs) onto the UE(s). The URSPs may be configured with rules that define the network slices that the VAL client(s) on the UE(s) are authorized to use when establishing PDU sessions for accessing certain VAL server(s). The configuration of the URSP policy(s) onto the UE may involve the NSCE server issuing request(s) to a function in the core network (e.g., NEF, PCF, etc.) to configure the URSP(s) onto the UE(s).

Alternatively, or in addition to, the NSCE server may send to the NSCE client on the UE, using a NSCE message, NSCE Client Configuration Rules (NCCR) for slice access that may include references to URSPs configured on the UE and/or information regarding NSSAI and/or DNN of the network slice instance(s) that the NSCE server allocated or modified for use by the VAL client(s) on the UE(s). The NSCE client may use these NCCR to reference URSPs configured on the UE. Alternatively, the NSCE client may use these NCCR, along with pre-provisioned policies, to create URSP rules or enhanced URSP rules. NCCR may also provide information about the triggers for creating or using alternate URSP rules. For example, the NSCE Client may derive or use alternate URSP rules with the same traffic descriptors and different route selection descriptors, associated with various triggering conditions present at the UE. The route descriptors derived by the NSCE Client allow the UE to utilize the new or newly configured network slice based on the triggering conditions. The triggering conditions included in NCCR may be the same as those described in table 5, or may be based on time, location, etc. The use may be different compared to Step 3, as in Step 3 they are used to trigger the UE network slice management requests, while when provided via NCCR they are used in changing URSP rules derived from NCCR. The two mechanisms may be used separately or jointly.

The URSPs may also comprise identifiers of the VAL client(s) on the UE(s) and/or identifiers of the VAL server(s) that these VAL client(s) are authorized to access using the specified network slice instances. The URSPs may also include rules specifying the allowed schedules that the VAL client(s) are permitted to access the network slice instances. These schedules may be configured such that they align with the expected usage schedules of one or more VAL client(s) on the UE. The URSPs may also include rules specifying the allowed locations or routes from which the VAL client(s) are permitted to access and use the network slice instances. These location(s) and route(s) may be configured such that they align with the expected location(s) and route(s) specified by one or more VAL client(s) on the UE. When the UE is not in the specified location(s) or traveling along the specified route(s), then based on the URSP(s), the VAL client(s) will not be permitted to access and use the network slice instances to communicate with the VAL server(s). For the case that the NSCE server requested new network slice authorizations for the UE, the NSCE server may need to request the 5G network to perform a UE Configuration Update procedure to provision the UE with the new network slice authorization information, e.g. in the Allowed NSSAI. The UE Configuration Update procedure may need to be performed prior to the update of the URSP to the UE to ensure proper network slice authorization is available in the UE prior to using the URSP rules.

At Step 11, the NSCE client may include in the request that it sends to the NSCE server (specified in Step 4) an indication for the NSCE server to try and obtain authorization privileges for the NSCE client to issue network slice management requests directly to network slice management functions in the system. If this indication is present, the NSCE server may initiate request(s) to other entities in the system (e.g., authorization server, OAM service) to try and obtain privileges for the NSCE client to issue network slice management requests directly to a network slice management function in the system such as a core network function (e.g., NEF, NSACF, etc.) or an OAM service. Within this request, the NSCE server may provide information elements such as those that it receives from the NSCE client defined in Table 6 and/or UE context information that it obtains such as the types of information defined in Table 7. In response, the NSCE server may receive an authorization decision indicating whether or not the NSCE is permitted to issues network slice management requests directly to the network slice management function in the system, one or more types of network slice management operations that the NSCE client is allowed to initiate, an authorization token that the NSCE client can use to authenticate itself with the network slice management function, and/or an authorization lifetime which indicates a time window or expiration time after which, the NSCE client can longer issue requests directly to the network slice management function.

At Step 12, after the NSCE server completes the processing of the network slice management request from the UE, the NSCE server may return a response to the NSCE client. In addition, the NSCE server may also send notification(s) to the NSCE client if/when the NSCE server detects network slice events of interest to the NSCE client have occurred. These notifications may be contingent on network slice notification criteria that the NSCE client provides to the NSCE server such as but not limited to the criteria defined in Table 6. The response and/or notification(s) may include one or more information elements such as but not limited to those defined in Table 8.

TABLE 8
Information Returned by NSCE Server
in Network Slice Management Response

| Information | |
|---|---|
| Element | Definition |
| Network slice | Indication (e.g., response or status code) of whether or |
| management | not the NSCE server was able to successfully process the |
| operation | network slice management request received from the |
| results | NSCE client. |
| network slice | Identifiers of one more network slices that the UE and |
| identifier(s) | VAL client(s) on the UE are permitted to access |
| network slice | A network slice descriptor may include one or more of |
| descriptor(s) | the following elements which the NSCE server |
| | configures: |
| | identifier (e.g., NSSAI, SST, etc.) of a network slice |
| | that VAL client(s) on the UE are permitted to use |
| | identifier(s) of VAL client(s) permitted to use the |
| | specified network slice |
| | identifier(s) of VAL server(s) that are permitted to be |
| | accessed by the specified VAL client(s) via the |
| | specified network slice |
| | scheduled time(s) that network slice is permitted to be |
| | used by the specified VAL client(s) to access the |
| | specified VAL server(s) |
| | UE location(s) from which the specified VAL |
| | client(s) are permitted to access the specified VAL |
| | servers via the network slice |
| | UE routes along which the specified VAL client(s) are |
| | permitted to access the specified VAL servers via the |
| | network slice |
| network slice | Notifications pertaining to network slice management |
| notification | events which the NSCE client is interested in being |
| event | notified about such as those specified by the NSCE client |
| | in Table 6. |
| URSP | Identifiers of one or more URSPs that have been |
| Identifier(s) | configured onto the UE via the NSCE server and core |
| | network as a result of the NSCE client's request to the |
| | NSCE server |
| URSP(s) | UE Route Selection Policy(s) that the NSCE server |
| | provides directly to the NSCE client for the case where |
| | the URSPs are not configured via the core network. The |
| | URSPs may include one or more of the network slice |
| | descriptor elements defined above in this table. |
| authorization | An indication of whether or not the NSCE client has been |
| decision | successfully authorized to issue requests to a network |
| | slice management function in the system |
| authorization | A token that the NSCE client is to include in any requests |
| token | it issues directly to a network slice management function |
| | in the system such that the requests are allowed |
| authorization | A time window or expiration time after which the NSCE |
| lifetime | client is longer allowed to issue requests directly to a |
| | network slice management function |
| authorized | One or more types of network slice management |
| operations | operations that the NSCE client is permitted to issue |
| | directly to a network slice management function |

At Step 13, if authorized, the NSCE client may issue network slice management requests directly to a network slice management function in the system (e.g., OAM service) rather than indirectly to a network slice management function via a NSCE server. When issuing the request(s), the NSCE client may include information elements such as but not limited to those defined in Table 6.

At Step 14, the NSCE client may receive a response from the network slice management function. The response may include one or more information elements as defined in Table 8.

At Step 15, after receiving responses and/or notifications from either an NSCE server or another network slice management function in the system, the NSCE client may process the responses and notifications. The processing may involve the NSCE client determining whether to initiate one or more network slice management operations to the NSCE server such as allocation, modification, or deallocation of network slice(s) for use by the VAL client(s) on the UE. The NSCE client may also send one or more notifications to VAL client(s) on the UE. These notifications may be to inform the VAL client(s) that PDU sessions can now be established since network slice resources are available to the UE, or of changes to network slices and/or PDU sessions corresponding to network slices that impact the VAL client(s). The notifications may also be to change the behavior of the VAL client(s). For example, the notifications can be used to modify (e.g., throttle) their communication pattern(s) based on the availability of resources within network slice(s) or to switch over to using different PDU sessions and network slices.

At Step 16, PDU sessions can be established between VAL client(s) and VAL server(s). These PDU sessions are established based on the URSP(s) that have been configured onto the UE as part of the UE initiated network slice management procedure. Hence the network slice instances associated with each PDU session meet the application requirements of the VAL client(s) using these PDU sessions. As the requirements of the VAL client(s) change over time and/or the UE moves and requires new network slices, the NSCE client continues to keep the URSP(s) and network slice instances updated and allocated to the UE. This ensures any changes in network requirements for the UE and VAL client(s) are managed while also ensuring that any unused network resources are freed up for use by other UEs.

### Graphical User Interface

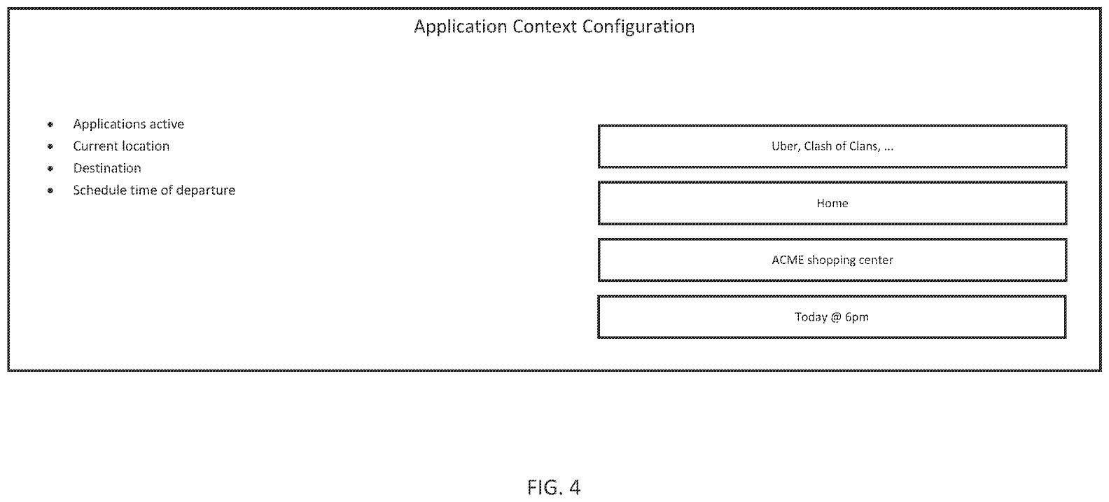

Context information may be collected from applications on the UE which may be useful for managing the network slice resources required by the UE. Certain types of context may be entered into one or more applications from users themselves during the use of the applications. FIG. 4 shows some examples of types of user-provided content information that may be entered via user(s). For example, when applications (e.g. Uber®, Clash of Clans®, etc.) are opened and/or closed via the UE's GUI, when information from is entered by the user into the applications (e.g., destination and scheduled time of departure time). These types of information can be used by the UE to provide more efficient, proactive, and dynamic management of network slice resources.

### Methods

Methods described herein can include a NSCE client that: is hosted on a UE, receives application context from one or more VAL clients hosted on the same UE which can be used by the NSCE client to make network slice management decisions, and wherein the application context may comprise but is not limited to one or more of the following informational elements: type(s) and/or instance(s) of VAL servers that the VAL clients require interaction with, the identifiers of one or more VAL clients hosted on other UEs that a VAL client on the local UE is currently or is planning to communicate with via one or more specified VAL servers, schedules of when the VAL clients are expected to be in operation and/or inactive, location or route of the UE when the VAL clients are scheduled to be in operation, a mobility and/or speed indication, a communication criticality indication, a communication direction and/or mode required and/or observed service KPIs of the VAL clients (e.g., end-to-end latency, jitter, bandwidth, reliability), observed user QoE KPIs such as user's satisfaction/dissatisfaction level while using an application or service, and wherein the NSCE client may receive the application context if/when events such as but not limited to one or more of the following occur: VAL client(s) transition to different VAL server(s); VAL client(s) transition to different VAL client(s); VAL client(s) schedule change occurs; UE/VAL client(s) location/route change; UE/VAL client(s) mobility change; VAL client(s) criticality change; VAL client(s) service continuity change; VAL client(s) edge service change; VAL client(s) communication direction change; VAL client(s) communication mode change; VAL client(s) end-to-end latency, jitter, bandwidth and/or reliability change; and VAL client(s) location accuracy change.

The NSCE client can also collect additional context to supplement the context received from the VAL clients, wherein the additional context gathered may comprise but is not limited to one or more of the following elements: configuration parameters and resources of each network slice allocated for use by the UE; network slice status; and network slice utilization.

The NSCE client can also process the received and/or collected context, wherein the processing may comprise but is not limited to one or more of the following operations: storing and maintaining a history of the received and/or collected context; aggregating the received and/or collected context to identify commonalities across VAL clients and/or users of VAL clients to determine overall network slice requirements of the UE; analyzing received, collected and/or historical context to detect patterns in the network slice requirements of the UE; detecting insufficient network slice(s), unused network slice(s) and under/over utilized network slice(s) for the UE and VAL client(s); and determine the set of network slice(s) required by the VAL client(s) on the UE.

The NSCE client can also transmit one or more requests to one or more NSCE servers in the network to perform network slice management operations, wherein the request comprises one or more of the following information elements: identifier(s) of the UE, VAL clients, VAL servers, NSCE client; application and/or user context received from one or more VAL clients; context collected by the NSCE client; one or more network slice operations that the NSCE client is requesting that the NSCE server perform on behalf of the NSCE client such as but not limited to: allocating, modifying, or deallocating a network slice; determined network slice requirements (e.g., slice type(s), slice usage schedule(s), slice usage location(s)) for one or more network slices required by the UE; an indication that the NSCE client is requesting the NSCE server to obtain authorization for the NSCE client such that the NSCE client is allowed to perform one or more network slice operations itself directly with an OAM service in the network; and network slice notification criteria and callback address.

The NSCE client can also receive response(s) or notification(s) from one or more NSCE servers in the network regarding one or more of the following types of information: Network slice management operation results; network slice identifier(s); network slice descriptor(s); network slice notification event(s); URSP Identifier(s); URSP(s); authorization decision; authorization token; authorization lifetime; and authorized operations.

Methods described herein can also include a NSCE server that is hosted on a server in the network, receives requests from one or more NSCE clients comprising information elements such as but not limited to one or more of the aforementioned informational elements exchanged between a NSCE client and the NSCE server, performs one or more network slice capability centric operations on behalf of the UE based on the information in the request, where the one or more operations may include but are not limited to: authenticating the NSCE client; obtaining authorization for the VAL client(s) on the UE(s) to access the VAL server(s) via the network slice instances, where obtaining authorization comprises one or more of the following operations: sending an authorization request to a service in the network (e.g., AS, EAS, authorization service) to obtain an authorization approval for the VAL client(s), querying entities in the system (e.g., OAM service) to determine whether network slice instances exist which already meet the minimum required service or QoE KPIs of the VAL client(s) on the specified UE(s) and whether these network slices have availability to the UE(s) at the required scheduled time(s), location(s) and/or routes, if adequate network slice instance(s) do not exist, then triggering the allocation of a new or modification of an existing network slice instance that comprises adequate network resources to meet the minimum required service or QoE KPIs of the VAL client(s) on the specified UE(s) and that have availability to the UE(s) at the required scheduled time(s), location(s) and/or routes, obtaining authorization for the VAL client(s) on the UE(s) to access the network slice instances, where obtaining authorization comprises one or more of the following operations: sending an authorization request to a service in the network (e.g., OAM service) to obtain an authorization approval indication (e.g., authorization token) for the NSCE client to perform one or more types of network slice management operations, configuring UE Route Selection Policy(s) (URSPs) on the UE(s) with rules that define the network slices that the VAL client(s) on the UE(s) are authorized to use to access VAL server(s), wherein configuring may involve: the NSCE server issuing request(s) to a function in the network to configure URSP(s) onto the UE(s), the NSCE server sending URSP(s) directly to the NSCE client to be configured on the UE(s), wherein each URSP may comprise one or more of the following information: the NSSAI and/or DNN of the network slice instance(s) that the NSCE server triggered allocating or modifying for use by the VAL client(s) on the UE(s), identifiers of the VAL client(s) on the UE(s) that are authorized to access the network slice instances, identifiers of the VAL server(s) that the VAL client(s) on the UE(s) are authorized to access via the network slice instances, the scheduled time(s) the VAL client(s) on the UE(s) are permitted to access the network slice instances which are configured with times that are aligned with the schedule requirements of the VAL clients, the location(s) from which the VAL client(s) on the UE(s) are permitted to access the network slice instances which are configured with locations that are aligned with the expected locations/routes of the VAL clients, obtain authorization for the NSCE client to perform one or more network slice operations itself directly with an OAM service in the network, and sending an authorization request to a service in the network (e.g., OAM service) to obtain an authorization approval indication (e.g., authorization token) for the NSCE client to perform one or more types of network slice management operations directly with a network slice management service in the network (e.g., OAM service).

The NSCE server can also send responses or notification requests to one or more NSCE clients on one or more UEs in the network regarding one or more of the following types of information: Network slice management operation results; network slice identifier(s); network slice descriptor(s); network slice notification event; URSP Identifier(s); URSP(s); authorization decision; authorization token; authorization lifetime; and authorized operations.

Note, in the context of this disclosure, VAL clients may be application clients or services hosted on a UE that provide functionality targeting a specific vertical, application or deployment use case (e.g., vehicular, healthcare, agriculture, mass transit, energy, etc.). Likewise, VAL servers may be application services hosted in the cloud or at the edge of the network and which are accessed by the application clients on the UE.

### Example Communications System

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHZ, and the provision of new ultra-mobile broadband radio access above 7 GHz. The flexible radio access is expected to consist of a new, non-backwards compatible radio access in new spectrum below 7 GHZ, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHZ, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

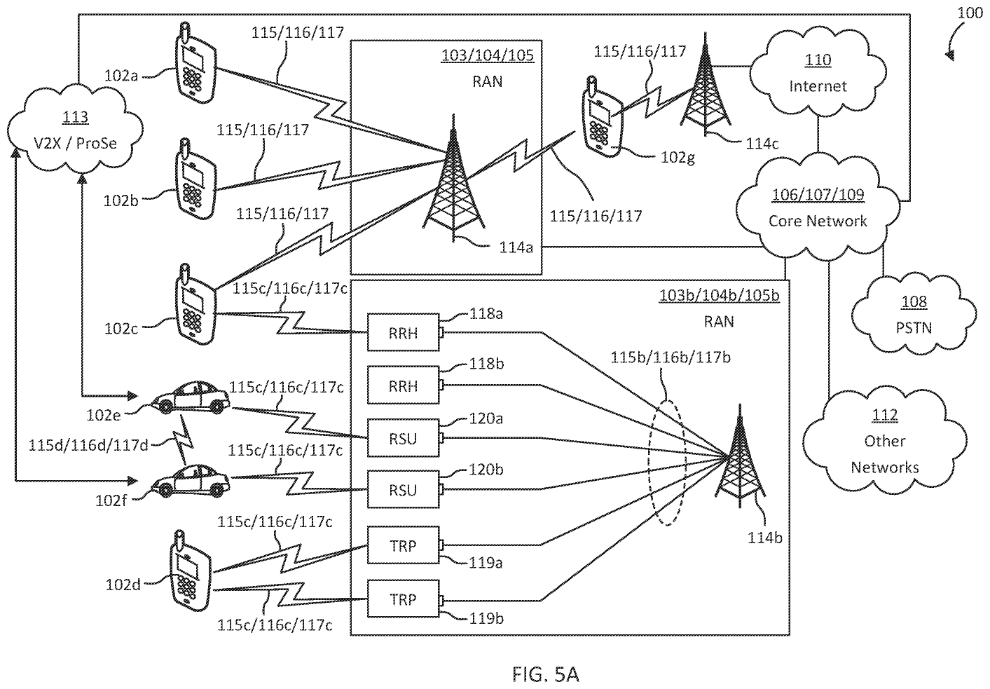

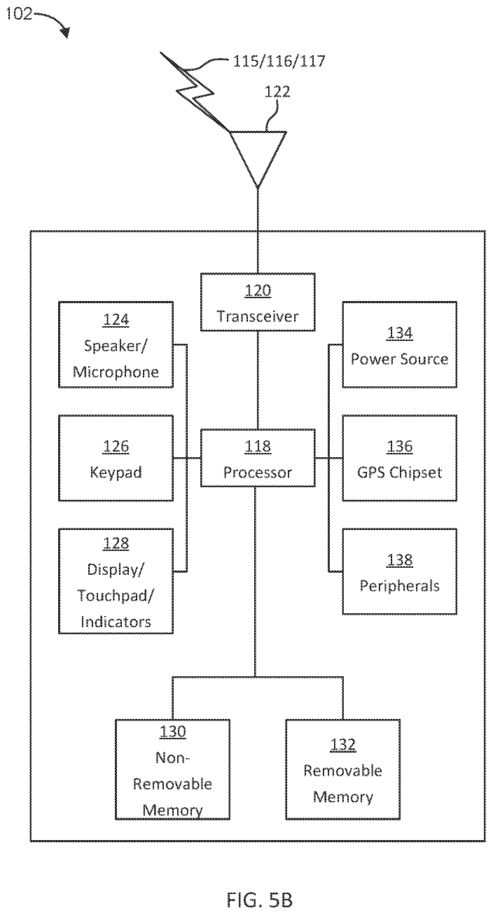

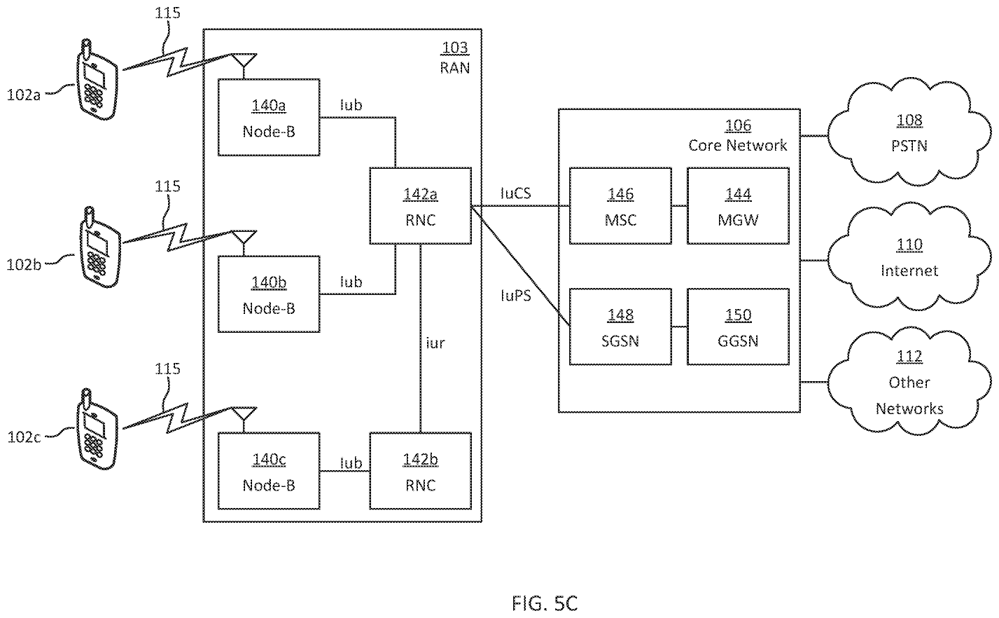

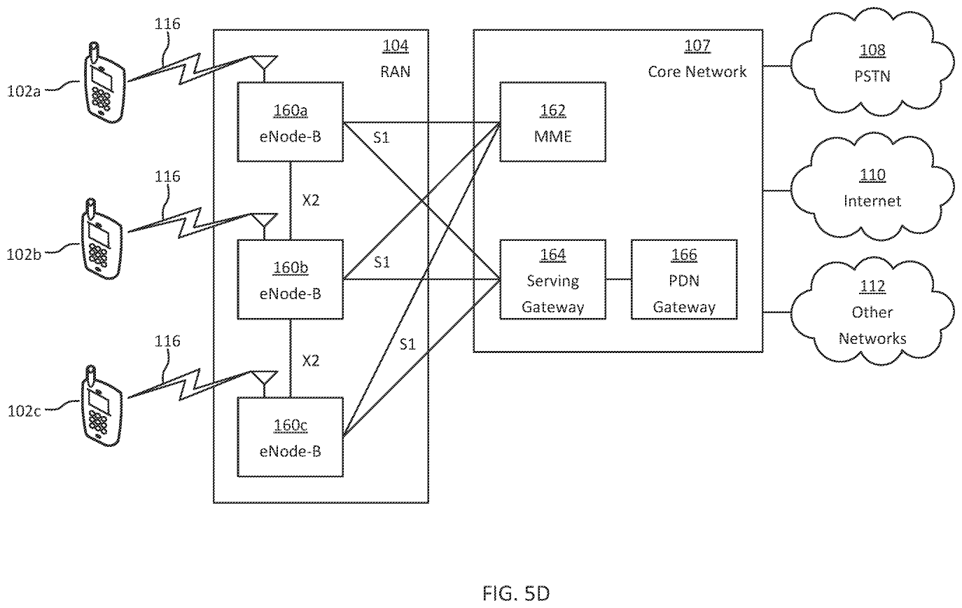

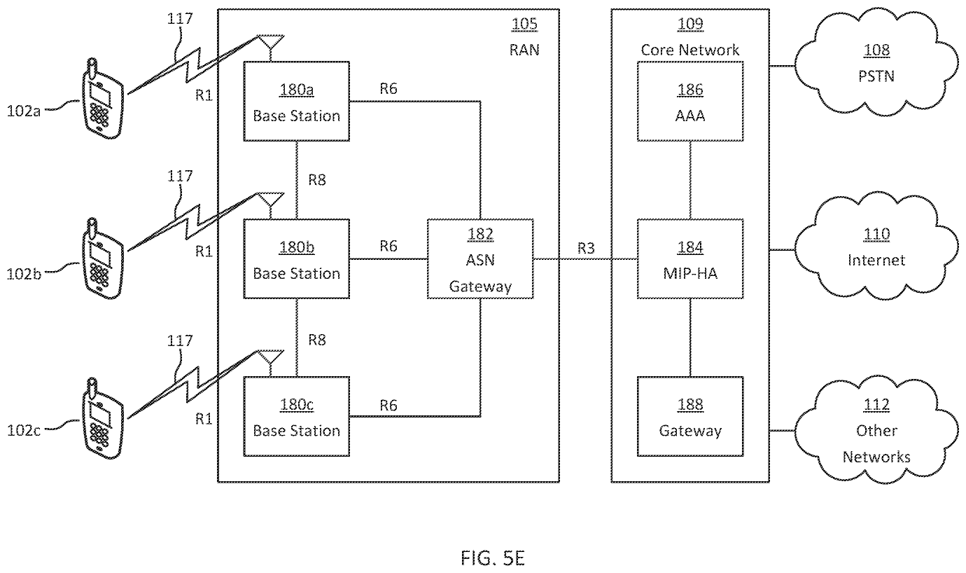

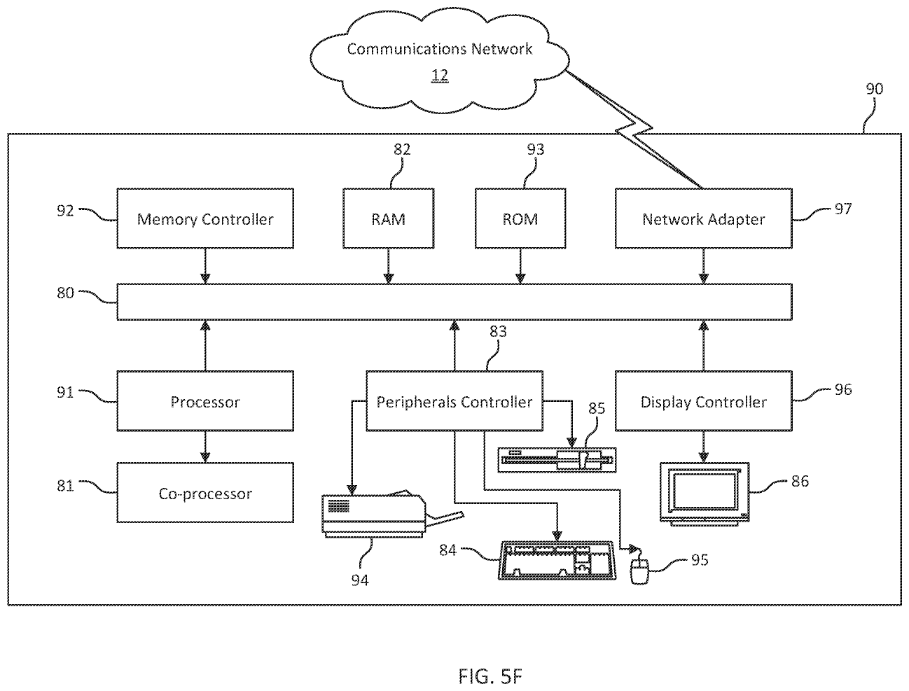

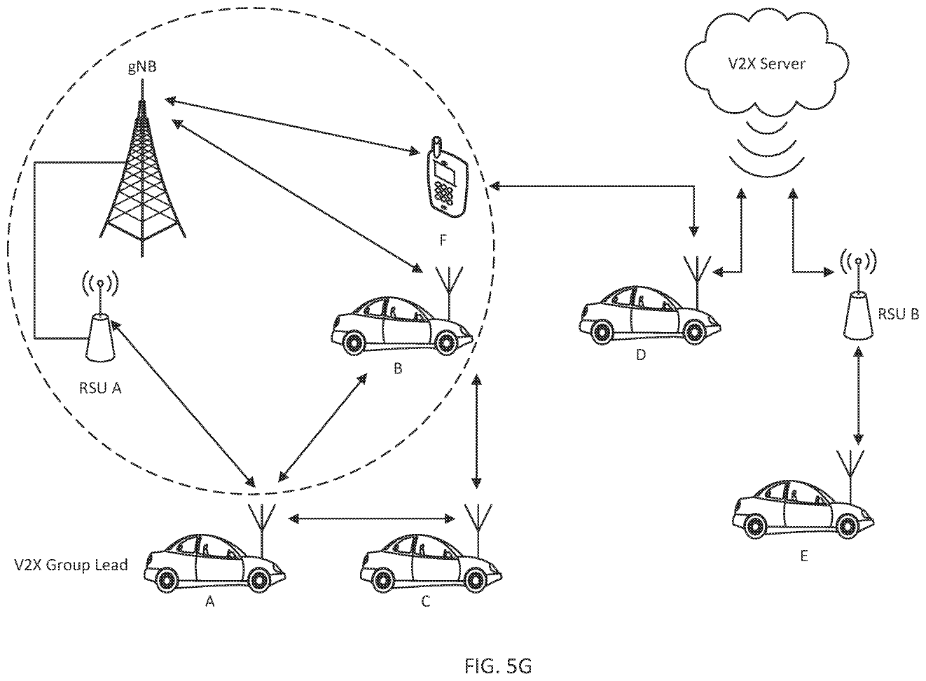

FIG. 5A illustrates an example communications system 100 in which the methods and apparatuses described and claimed herein may be an aspect of. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed examples contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 5A-5E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, the base station 114a may include three transceivers, e.g., one for each sector of the cell. In some cases, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In some cases, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In some cases, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 5A may be a wireless router, Home Node B, Home eNode B, or access point, for example, and may utilize any suitable RAT for facilitating wireless connectivity in a localized area, such as a place of business, a home, a vehicle, a campus, and the like. In some cases, the base station 114c and the WTRUs 102e, may implement a radio technology such as IEEE 802.11 to establish a wireless local area network (WLAN). In some cases, the base station 114c and the WTRUs 102d, may implement a radio technology such as IEEE 802.15 to establish a wireless personal area network (WPAN). In some cases, the base station 114c and the WTRUs 102e, may utilize a cellular-based RAT (e.g., WCDMA, CDMA2000, GSM, LTE, LTE-A, etc.) to establish a picocell or femtocell. As shown in FIG. 5A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VOIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 5A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 5A may be configured to communicate with the base station 114a, which may employ a cellular-based radio technology, and with the base station 114c, which may employ an IEEE 802 radio technology.

FIG. 5B is a block diagram of an example apparatus or device configured for wireless communications in accordance with the aspects illustrated herein, such as for example, a WTRU 102. As shown in FIG. 5B, the example WTRU 102 may include a processor 118, a transceiver 120, a transmit/receive element 122, a speaker/microphone 124, a keypad 113, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an example. Also, in some cases the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 5B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 5B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in some cases, the transmit/receive element 122 may be an antenna configured to transmit and/or receive RF signals. In some cases, the transmit/receive element 122 may be an emitter/detector configured to transmit and/or receive IR, UV, or visible light signals, for example. In some cases, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 5B as a single element, the WTRU 102 may include any number of transmit/receive elements 122. More specifically, the WTRU 102 may employ MIMO technology. Thus, in some cases, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In some cases, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an aspect.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 5C is a system diagram of the RAN 103 and the core network 106. As noted above, the RAN 103 may employ a UTRA radio technology to communicate with the WTRUs 102a, 102b, and 102c over the air interface 115. The RAN 103 may also be in communication with the core network 106. As shown in FIG. 5C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an aspect of the disclosure.

As shown in FIG. 5C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 5C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 5D is a system diagram of the RAN 104 and the core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an aspect of the disclosure. The eNode-Bs 160a, 160b, 160c may each include one or more transceivers for communicating with the WTRUs 102a, 102b, 102c over the air interface 116. In some cases, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 5D, the eNode-Bs 160a, 160b, 160c may communicate with one another over an X2 interface.

The core network 107 shown in FIG. 5D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the SI interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 5E is a system diagram of the RAN 105 and the core network 109. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 5E, the RAN 105 may include base stations 180a, 180b, 180c, and an ASN gateway 182, though it will be appreciated that the RAN 105 may include any number of base stations and ASN gateways while remaining consistent with an aspect of the disclosure. The base stations 180a, 180b, 180c may each be associated with a particular cell in the RAN 105 and may include one or more transceivers for communicating with the WTRUs 102a, 102b, 102c over the air interface 117. In some cases, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QOS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 5E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 5E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 5A, 5C, 5D, and 5E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 5A, 5B, 5C, 5D, and 5E are provided by way of example only, and it is understood that the subject matter disclosed and claimed herein may be embodied or implemented in any similar communication system, whether presently defined or defined in the future.

FIG. 5F is a block diagram of an exemplary computing system 90 in which one or more apparatuses of the communications networks illustrated in FIGS. 5A, 5C, 5D and 5E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 5A, 5B, 5C, 5D, and 5E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 5G illustrates an example communications system 111 in which the methods and apparatuses described and claimed herein may be an aspect of. As shown, the example communications system 111 may include wireless transmit/receive units (WTRUs) A, B, C, D, E, F, a base station, a V2X server, and a RSUs A and B, though it will be appreciated that the disclosure contemplates any number of WTRUs, base stations, networks, and/or network elements. One or several or all WTRUs A, B, C, D, E can be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

### Definitions

Provided below are definitions for abbreviations found within the body of the disclosure.

| | |
|---|---|
| 3GPP | Third Generation Partnership Project |
| 5GS | 5G System |
| AF | Application Function |
| API | Application Programming Interface |
| AS | Application Server |
| CN | Core Network |
| DNN | Data Network Name |
| EAS | Edge Application Server |
| EEC | Edge Enabler Client |
| EES | Edge Enabler Server |
| ECS | Edge Configuration Server |
| GUI | Graphical User Interface |
| KPI | Key Performance Indicator |
| MNO | Mobile Network Operator |
| NEF | Network Exposure Function |
| NS | Network Slice |
| NSACF | Network Slice Access Control Function |
| NSCALE | Network Slice Capability Application Layer Exposure |
| NSCE | Network Slice Capability Exposure |
| NSI | Network Slice Instance |
| NSSAI | Network Slice Selection Assistance Information |
| OAM | Operations, Administration and Maintenance |
| PCF | Policy Control Function |
| PLMN | Public Land Mobile Network |
| QoE | Quality of Experience |
| QoS | Quality of Service |
| RAN | Radio Access Network |
| SEAL | Service Enabler Architecture Layer for Verticals |
| SST | Slice Service Type |
| UDR | Unified Data Repository |
| UE | User Equipment |
| URSP | UE Route Selection Policy |
| VAL | Vertical Application Layer |

What is claimed:

1. A method comprising:
receiving, by a Network Slice Capability Exposure (NSCE) client of a user equipment (UE) and from a Vertical Application Layer (VAL) client of the UE, context information comprising a location requirement, a time window requirement, or a network access type preference;
determining, by the NSCE client and based on the received context information, one or more network slices required by the VAL client;
generating, by the NSCE client, one or more network slice management requests corresponding to the determined one or more network slices, wherein the one or more network slice management requests comprise a location requirement, a time window requirement, or an access type preference;
transmitting, by the NSCE client and to one or more NSCE servers, the generated one or more network slice management requests; and
receiving, by the NSCE client and from the one or more NSCE servers, one or more responses indicating whether one or more network slices were configured to meet requirements specified in the one or more requests.

2. The method of claim 1, wherein the location requirement further comprises locations or routes where the UE requires usage of network slices.

3. The method of claim 1, wherein the time window requirement further comprises schedules of when the UE requires usage of network slices.

4. The method of claim 1, wherein the network access type preference further comprises a type of applicable access network for network slices.

5. The method of claim 4, wherein the type of access network comprises a 3GPP, non-3GPP or multi access network.

6. The method of claim 1, further comprising:
receiving, by the NSCE client and from the one or more NSCE servers, and in response to the transmitted one or more network slice management requests, a set of NSCE Client Configuration Rules (NCCR) corresponding to slice access management for the VAL client; and
generating, by the NSCE client and based on the set of NCCR, a UE Route Selection Policy (URSP) for slice access authorization for the VAL client.

7. The method of claim 1, further comprising:
transmitting, by the NSCE client and to the one or more NSCE servers, an indication for the one or more NSCE servers to obtain authorization privileges for the NSCE client to issue network slice management requests directly to network slice management functions; and
receiving, by the NSCE client and from the one or more NSCE servers, an authorized permission message indicating the authorization privileges are granted.

8. A method comprising:
transmitting, by a Network Slice Capability Exposure (NSCE) client of a user equipment (UE) and to one or more NSCE servers, a subscription request comprising network slice event information corresponding to a first network slice used by the UE for wireless communications;
receiving, by the NSCE client, a notification indicating a network slice adaptation for the UE; and
causing, by the NSCE client and based on the notification, the UE to switch from using the first network slice to a second network slice.

9. The method of claim 8, wherein the network slice event information comprises an identifier of the first network slice.

10. The method of claim 8, wherein the network slice event information comprises one or more network slice events of interest.

11. The method of claim 10, wherein the one or more network slice events of interest further comprises a network slice adaptation or a network slice error.

12. The method of claim 8, wherein the notification further comprises an identifier of the second network slice.

13. The method of claim 8, further comprising:
determining, by the NSCE client and based on the notification, the second network slice for the UE to switch to.

14. The method of claim 8, further comprising:
receiving, by the NSCE client, a message indicating authorization for sending network slice management requests directly to a network slice management function; and wherein the notification is received from the network slice management function.

15. A method comprising:
receiving, by one or more Network Slice Capability Exposure (NSCE) servers and from a NSCE client of a user equipment (UE), one or more network slice management requests, wherein the one or more network slice management requests comprise contextual information associated with the UE, the contextual information comprising at least a location requirement, a time window requirement, or an access type preference;
determining, by the one or more NSCE servers and based on the received contextual information, a number of network slice instances the UE is configured to use; and
transmitting, by the one or more NSCE servers and to the NSCE client, one or more responses indicating whether one or more network slices were configured to meet requirements specified in the one or more requests.

16. The method of claim 15, further comprising:
transmitting, by the one or more NSCE servers and to one or more core network functions, one or more requests for additional contextual information corresponding to the one or more network slice management requests;
receiving, by the one or more NSCE servers and from the one or more core network functions, the additional contextual information, wherein the additional contextual information comprises: location information for one or more UEs targeted for communication by the UE, current network slices permitted for use by the UE, UE Route Selection Policies (URSPs) configured for current use by the UE, or a combination thereof; and
wherein determining the number of network slice instances the UE is configured to use is further based on the additional contextual information.

17. The method of claim 15, wherein determining the number of network slice instances the UE is configured to use comprises determining whether the UE is permitted to implement the number of network slice instances.

18. The method of claim 15, wherein the transmitted one or more responses comprise a set of NSCE Client Configuration Rules (NCCR) corresponding to slice access management for the UE, wherein the NCCR indicate one or more triggers for the UE to modify UE Route Selection Policies (URSPs) configured for current use by the UE.

19. The method of claim 15, wherein the location requirement further comprises locations or routes where the UE requires usage of network slices.

20. The method of claim 15, wherein the time window requirement further comprises schedules of when the UE requires usage of network slices.
